(19) United States
(12) Patent Application Publication
(10) Pub. No.: US 2017/0250925 A1
(43) Pub. Date: Aug. 31, 2017

(54) METHOD AND DEVICE FOR ESTIMATING WORKLOAD OF NETWORK FUNCTION

(71) Applicant: FUJITSU LIMITED, Kawasaki-shi (JP)

(72) Inventors: Dai SUZUKI, Kawasaki (JP); SATOSHI IMAI, Kawasaki (JP)

(73) Assignee: FUJITSU LIMITED, Kawasaki-shi (JP)

(21) Appl. No.: 15/398,117

(22) Filed: Jan. 4, 2017

(30) Foreign Application Priority Data
Feb. 25, 2016 (JP) 2016-034116

(51) Int. Cl. H04L 12/911; H04L 12/24; H04L 12/863

(52) U.S. Cl. CPC H04L 47/82; H04L 47/6255; H04L 41/20

(57) ABSTRACT

A workload estimation method estimates a workload of a network function that processes a received flow based on a rule searched for from among a plurality of rules. The method that is executed by a processor includes: obtaining information that indicates maximum throughputs of the network function respectively for the rules; measuring traffic volumes of flows that respectively match the rules; calculating ratios of the measured traffic volumes to the maximum throughputs respectively for the rules; and estimating a workload of the network function based on a sum of the ratios calculated respectively for the rules.

### CROSS-REFERENCE TO RELATED APPLICATION

This application is based upon and claims the benefit of priority of the prior Japanese Patent Application No. 2016-034116, filed on Feb. 25, 2016, the entire contents of which are incorporated herein by reference.

### FIELD

The embodiments discussed herein are related to a method and a device for estimating a workload of a network function.

### BACKGROUND

In recent years, NFV (Network Functions Virtualization), which virtualizes network functions, are attracting attention. NFV can implement network functions through an application operating on a general-purpose server. This can reduce costs for network devices. Also, NFV may provide higher flexibility and higher functionality for network services.

However, virtualization of a network function makes it difficult to know the maximum processing performance (which will also be referred to simply as “performance”) of that network function. This is because the performance of a network function depends upon the virtualization environment and the setting contents of that network function. For example, the maximum throughput of a network function that performs table search processes in a firewall, a router, etc. depends upon the number of times that the tables are searched. This makes packet loss more likely to occur in a flow in which tables are searched many times than in a flow in which tables are searched not so many times even when the flows are carrying the same traffic volume. Also, a network designed without accurate knowledge of the performance of the network function involves a risk that an excessive load will cause packet loss. On the other hand, when an excessively high value is set as a maximum traffic for avoiding packet loss, the efficiency in the use of the network resources is reduced. Therefore, accurate evaluation of the performance of a network function is important in order to use NFV effectively.

The performance of a network function is evaluated based on for example the CPU usage rate. In a case where for example a physical server is used for providing a network function, the performance of the network function is evaluated based on the CPU usage rate of that physical server. Alternatively, in a case where a virtual machine is used for providing a network function, the performance of the network function is evaluated based on the usage rate of the CPU that is assigned to the virtual machine. In this example, a CPU usage rate indicates a current workload of a network function or an excess processing capacity of a network function. Thus, the performance of a network function (e.g., the maximum throughput) can be estimated based on the CPU usage rate.

A method is proposed that minimizes the facility and operation costs while satisfying quality conditions in a network that is providing services (for example, Japanese Laid-open Patent Publication No. 2012-44487). In addition, a method for dynamically providing resources to wireless communications is proposed (Japanese National Publication of International Patent Application No. 2011-530235).

Incidentally, when a network function performs a table search process, it is sometimes not possible to accurately evaluate the performance of the network function based on the CPU usage rate. As an example, the applicant of the present patent application measured relationships between the volume of traffic that flows into the network function, the CPU usage rate and the maximum throughput in the experimental environment below.

A firewall is configured on a physical server by using iptables, which is software based on a Linux standard. 1000 rules are set on a rule table of the firewall. The matching condition of each rule is the source MAC address of a packet. The 1st through 999th rules respectively discard packets that match the conditions. The 1000th rule permits forwarding of a packet that matches the condition. The CPU searches the rule table by using the source MAC address of a received packet. A search process is sequentially performed from the 1st rule toward the 1000th rule until a rule that matches the received packet is detected. When for example a packet that matches the 1st rule is input, the CPU performs a table search only once. When a packet that matches the 1000th rule is input, the CPU performs a table search 1000 times. The packet processor transmits a packet that matches the 1000th rule at a specified transmission rate. The CPU usage rate is measured while changing the transmission rate of the packets. In addition, packet loss is measured by monitoring packets output from the firewall. Note that the firewall only outputs a packet that matches the 1000th rule.

FIG. 1 illustrates an example of a result of measurement of the CPU usage rate and the packet loss with respect to a traffic volume. This measurement indicates a characteristic tendency of the CPU usage rate with respect to the traffic volume. Specifically, the CPU usage rate remains almost unchanged in a region with a low transmission rate. However, the CPU usage rate abruptly increases with a transmission rate exceeding a specified threshold (approximately 180000 fps in FIG. 1). Also, packet loss occurs with a transmission rate exceeding 220000 fps. In this case, the maximum throughput is 220000 fps.

As described above, when a network function performs a table search process, the CPU usage rate does not increase linearly with respect to the transmission rate. For example, when a transmission rate increases from 40000 fps to 180000 fps, it is believed that the workload of the network function also increases similarly. However, the CPU usage rate does not change greatly even when the transmission rate has increased from 40000 fps to 180000 fps. This makes it difficult to estimate a workload based on a CPU usage rate.

The performance of a network function is estimated based on a relationship between the traffic volume and the workload of the network function. Accordingly, when a workload is not estimated accurately, it is difficult to accurately estimate the performance of the network function. In the measurement result illustrated in FIG. 1 for example, the maximum throughput is 220000 fps. However, the CPU usage rate is about 20 percent when traffic that accounts for about 80 percent of the maximum throughput is flowing. Thus, it is difficult to estimate the maximum throughput (i.e., the performance of the network function) from the CPU usage rate. Note that when the performance of a network function is not estimated accurately, packet loss may occur and efficiency in the use of the network resources is reduced.

### SUMMARY

According to an aspect of the present invention, a workload estimation method for estimating a workload of a network function that processes a received flow based on a rule searched for from among a plurality of rules includes: obtaining, by a processor, information that indicates maximum throughputs of the network function respectively for the rules; measuring, by the processor, traffic volumes of flows that respectively match the rules; calculating, by the processor, ratios of the measured traffic volumes to the maximum throughputs respectively for the rules; and estimating, by the processor, a workload of the network function based on a sum of the ratios calculated respectively for the rules.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of a result of measurement of a CPU usage rate and packet loss;

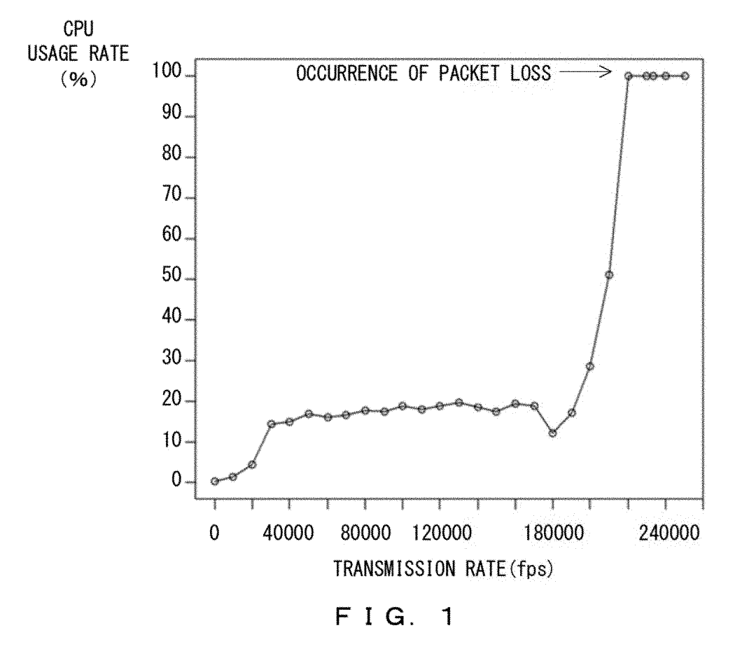

FIG. 2 illustrates an example of an NFV system;

FIG. 3 illustrates an example of a network system in which a workload estimation method according to embodiments of the present invention is used;

FIG. 4 illustrates an example of a configuration of a network device;

FIG. 5 illustrates an example of a rule table;

FIG. 6 is a flowchart illustrating an example of a method of searching the rule table;

FIG. 7 illustrates an example of a workload estimator;

FIG. 8 illustrates an example of a measurement system that measures a maximum throughput;

FIG. 9 is a flowchart illustrating an example of a method of estimating a workload of a network function;

FIG. 10 illustrates an example of measured values of maximum throughputs;

FIG. 11 illustrates examples of traffic volumes of flows that respectively match rules;

FIG. 12 illustrates an example of a calculation result of a workload WL;

FIG. 13 illustrates another example of a calculation result of workload WL;

FIGS. 14A-14C illustrate comparison between approximation values and measured values of maximum throughputs; and

FIG. 15 is a flowchart illustrating an example of a method of calculating a maximum throughput by using the approximation formula.

### DESCRIPTION OF EMBODIMENTS

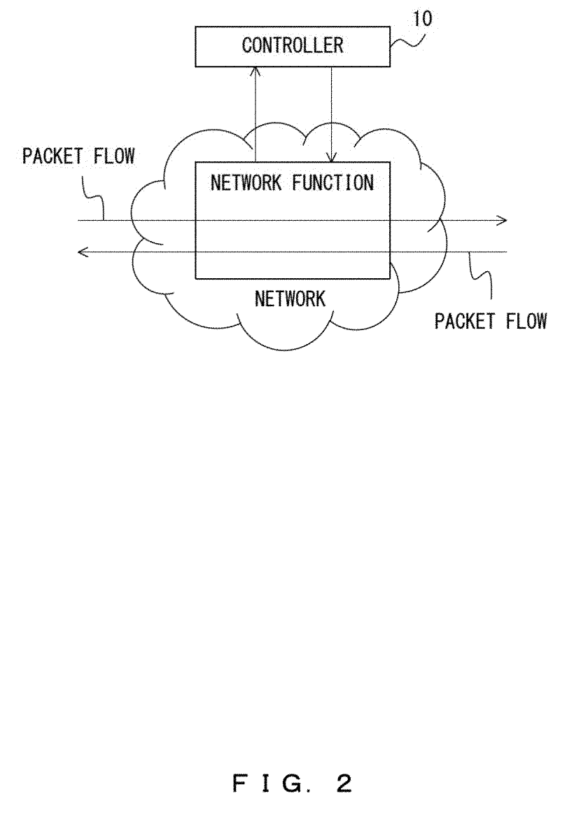

FIG. 2 illustrates an example of an NFV (Network Functions Virtualization) system. In the NFV system, a function provided by a network (which will hereinafter be referred to as a network function) is virtualized. Therefore, the network function may be implemented by an application that operates on a general-purpose server. For example, a router provided to a node in the network is implemented by an application that provides a packet forwarding function. Also, the firewall is implemented by an application that discards or forwards a packet in accordance with a specified rule.

A controller 10 controls network functions. In other words, a network function processes a packet flow in the network in accordance with the control by the controller 10. Also, the controller 10 collects, from the network function, information used for controlling the network function. For example, the controller 10 collects information indicating a traffic volume in the network.

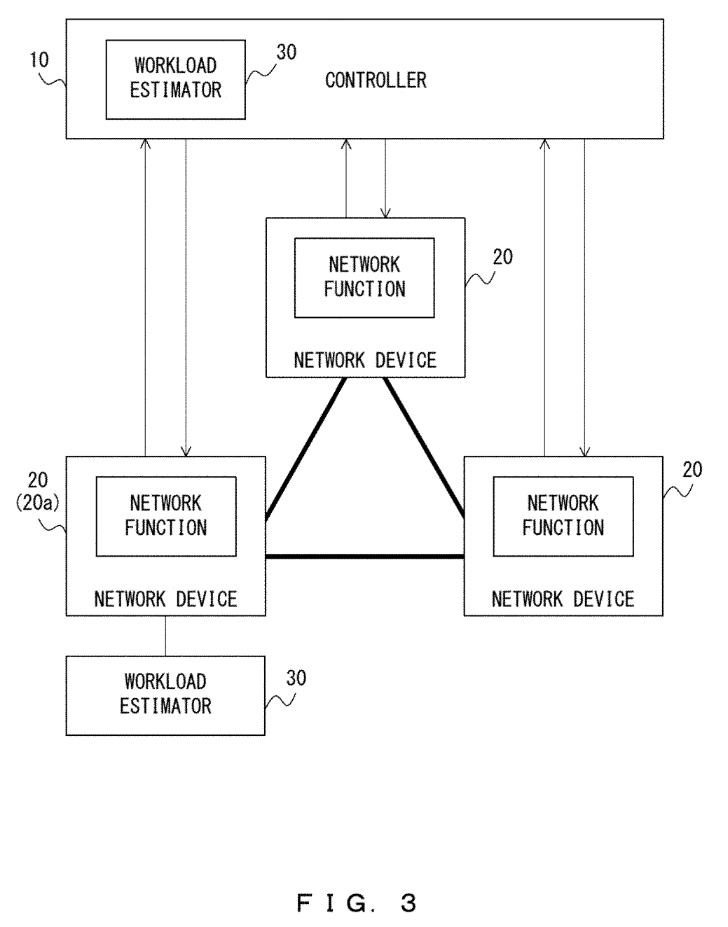

FIG. 3 illustrates an example of a network system in which a workload estimation method according to an embodiment of the present invention is used. The network system includes the controller 10 and a plurality of network devices 20. The network devices 20 are provided for example in nodes in the network. Also, the network device 20 is connected to other network devices 20 via for example an optical fiber link. Alternatively, a wireless link may be used for connecting the network devices 20.

The controller 10 provides, to the network devices 20, a program and data for controlling a network function. When for example the network device 20 configures a firewall, the controller 10 provides, to that network device 20, an application program and rule information for implementing a firewall. Then, the network device 20 executes the application program so as to provide a firewall function based on the provided rule information. In other words, the network device 20 can provide a network function in accordance with control by the controller 10.

The controller 10 collects information used for controlling network functions from the network devices 20. For example, the controller 10 can collect information indicating a traffic volume from the network device 20.

A workload estimator 30 estimates the workload of a network function. A workload in this example represents the level of a load on a network function. For example, a workload may represent a ratio of a capacity that is actually used to the maximum capacity of a network function. Note that a workload of a network function is not proportional to the CPU usage rate but depends upon the CPU usage rate, the memory usage rate, the usage rate of network resources, etc.

The workload estimator 30 is connected to the network device 20a in the example of FIG. 3. In such a case, the workload estimator 30 can estimate the workload of a network function provided by the network device 20a. Also, the workload estimator 30 may be provided in the controller 10. In such a case, the workload estimator 30 can estimate the workload of the network function provided by each of the plurality of network devices 20. Alternatively, the workload estimator 30 may be included in each of the network devices 20.

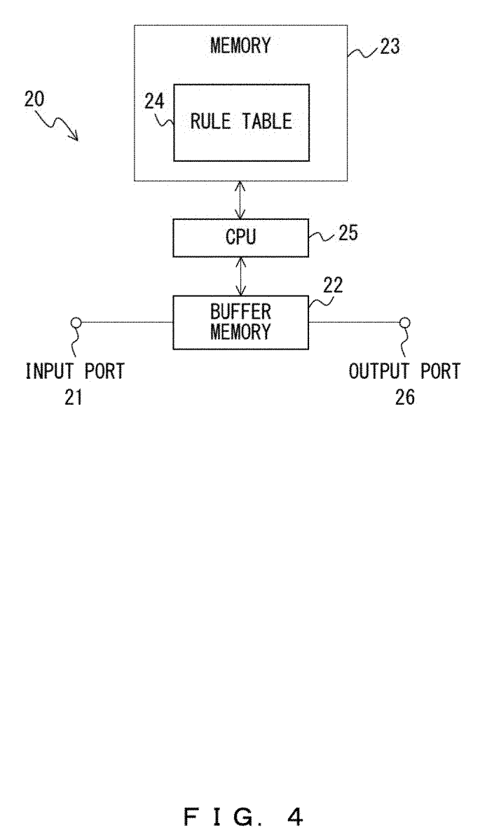

FIG. 4 illustrates an example of a configuration of the network device 20. In this example, the network device 20 includes an input port 21, a buffer memory 22, a memory 23, a CPU 25 and an output port 26. The network device 20 may be equipped with a plurality of input ports 21 and a plurality of output ports 26. Also, the network device 20 may further include a circuit element that is not illustrated in FIG. 4.

The buffer memory 22 temporarily stores a received packet. In other words, a received packet that arrives at the input port 21 is stored in the buffer memory 22. The memory 23 stores information for providing a network function. In this example, the memory 23 stores a rule table 24. Note that data set in the rule table 24 is provided from for example the controller 10 illustrated in FIG. 2 or FIG. 3.

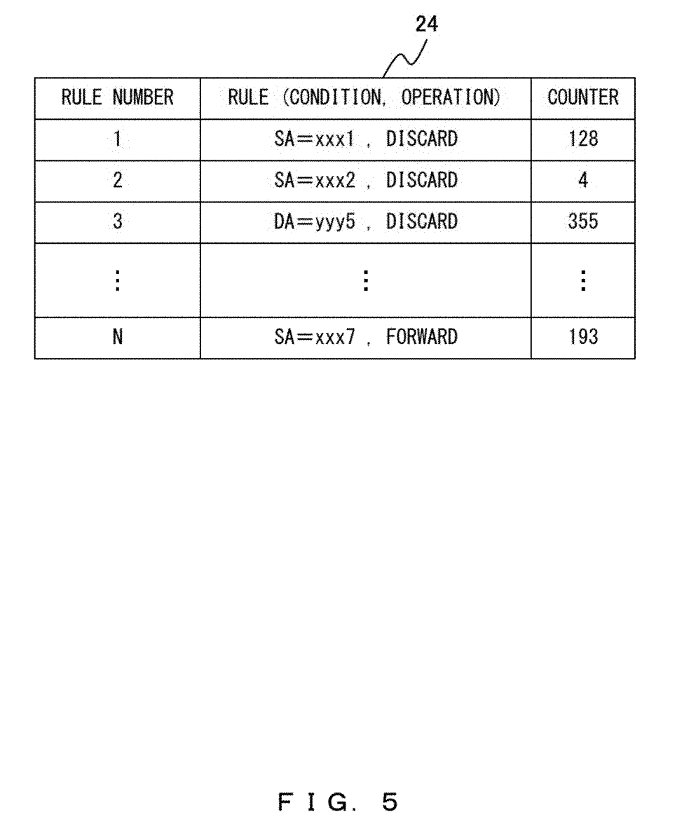

FIG. 5 illustrates an example of the rule table 24. A plurality of rules are registered in the rule table 24. Each rule is expressed by “condition” and “operation” in this example. A condition is used for deciding whether to process a received packet in accordance with the rule. An operation represents an operation that is to be performed for a received packet meeting a condition. For example, rule 1 illustrated in FIG. 5 indicates that “when a source address SA of a received packet is xxx1, that packet is to be discarded”. Also, rule N indicates that “when a source address SA of a received packet is xxx7, that received packet is to be forwarded to the destination. “Counter” will be described later.

The CPU 25 processes a received packet based on a header of that received packet stored in the buffer memory 22. In the process, the CPU 25 searches the rule table 24 based on header information stored in the header of the received packet. Then, the CPU 25 determines a rule that matches the header information so as to determine an operation for that received packet. When for example the source address SA of a received packet is “xxx1”, rule 1 is determined in the rule table 24. In such a case, the CPU 25 discards the received packet stored in the buffer memory 22 in accordance with rule 1. Also, when the source address SA of a received packet is “xxx7”, rule N is determined in the rule table 24. In such a case, in accordance with rule N, CPU 25 forwards the received packet stored in the buffer memory 22, to a destination via the output port 26.

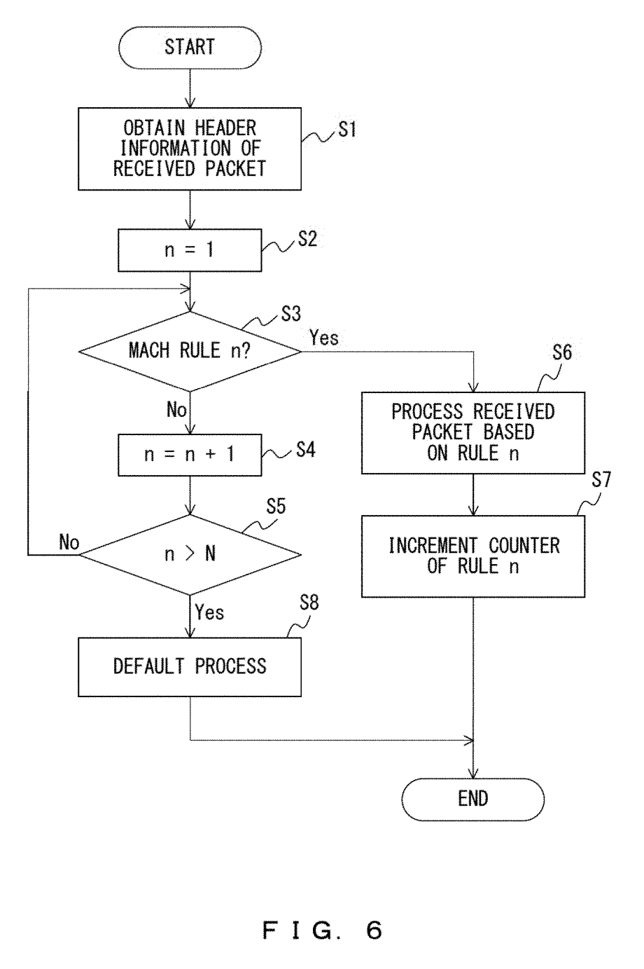

FIG. 6 is a flowchart illustrating an example of a method of searching the rule table 24. The process of this flowchart is performed when a received packet is stored in the buffer memory 22 in the network device 20 illustrated in FIG. 4.

In S1, the CPU 25 obtains header information of a received packet. Header information obtained by the CPU 25 includes for example source address SA, destination address DA, a port number, etc. In S2, the CPU 25 initializes variable n to “1”. Variable n is an integer for identifying N rules that are registered in the rule table 24.

In S3, the CPU 25 decides whether the header information obtained in S1 matches rule n. Specifically, whether the header information obtained in S1 matches “condition” of rule n is decided. When the header information does not match rule n, the CPU 25 increments variable n by one in S4. In S5, the CPU 25 decides whether variable n is greater than N. N represents the number of rules that are registered in the rule table 24. When variable n is smaller than or equal to N, the process of CPU 25 returns to S3.

In S3-S5, the CPU 25 searches for a rule that matches the header information of a received packet in N rules registered in the rule table 24. When rule n that matches the received packet is determined, the CPU 25 processes that received packet in accordance with the determined rule n. Further in S7, the CPU 25 increments the counter corresponding to rule n that matches the received packet in the rule table 24. In other words, the counter in rule table 24 illustrated in FIG. 5 represents the number of packets that match respective rules 1-N. Note that the counter illustrated in FIG. 5 may be included in the rule table 24 or may be provided independently from the rule table 24.

When the received packet does not match any of the rules, the CPU 25 performs a default process in S8. Ina default process, the CPU 25 may discard the received packet.

As described above, CPU 25 sequentially performs a search from rule 1 toward rule N until a received packet matches one of the N rules that are registered in the rule table 24. Therefore, a period of a searching time for the rule table 24 depends upon the rule number of the rule that matches a received packet. When for example a packet having header information that matches rule 1 arrives at the network device 20, the CPU 25 can determine a rule that matches the received packet by performing the search process in S3 of FIG. 6 only once. Also, when a packet having header information that matches rule 2 arrives at the network device 20, the CPU 25 can determine a rule that matches the received packet by performing the search process in S3 twice. In other words, when a packet having header information that matches rule n arrives at the network device 20, the CPU 25 can determine a rule that matches the received packet by performing the search process in S3 n times.

Note that a flow of a packet or a frame may be referred to just as a “flow” in this specification. A flow is identified based on for example the header information of each packet. In other words, a flow is identified by for example an address (MAC address, IP address, etc.) or a port number of TCP/UDP stored in a header, or by a combination thereof.

In the network device 20, the CPU 25 can identify a flow based on the header information of a received packet. A flow that is identified based on the header information of a received packet may be referred to as a “received flow” hereinafter. The CPU 25 determines a rule that matches a received flow so as to process that received flow in accordance with the determined rule.

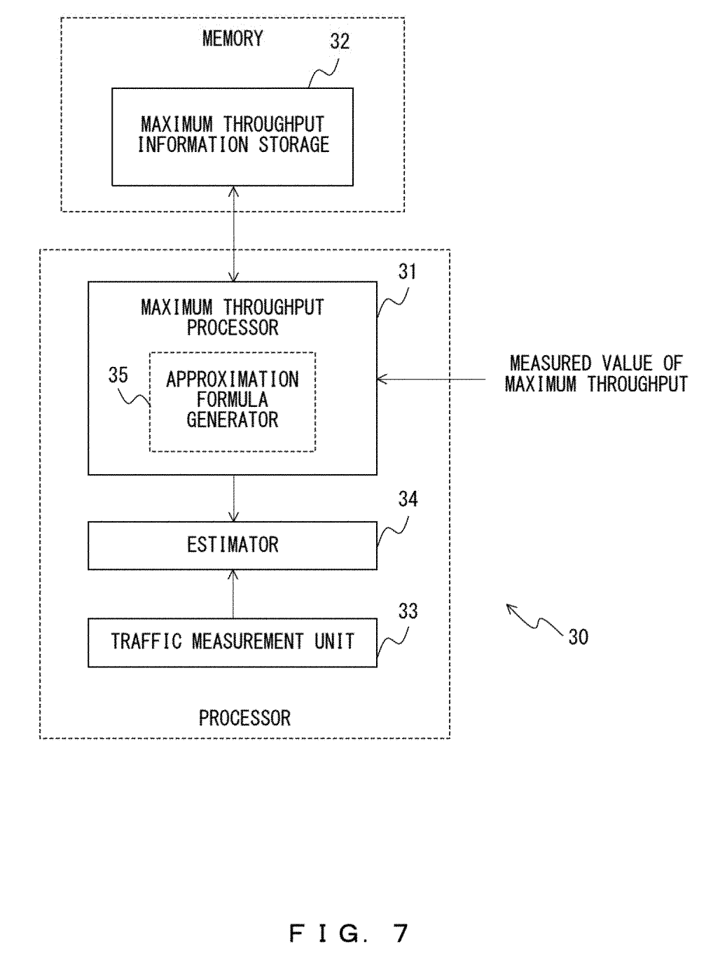

FIG. 7 illustrates an example of the workload estimator 30. In the example illustrated in FIG. 7, the workload estimator 30 includes a maximum throughput processor 31, a maximum throughput information storage 32, a traffic measurement unit 33 and an estimator 34. The maximum throughput processor 31, the traffic measurement unit 33 and the estimator 34 are implemented by executing, by using a processor, a given workload estimation program. In such a case, the workload estimation program includes a code for implementing the functions of the maximum throughput processor 31, the traffic measurement unit 33 and the estimator 34. When the workload estimator 30 includes an approximation formula generator 35, the workload estimation program also includes a code for implementing the function of the approximation formula generator 35. The workload estimation program is recorded in a processor-readable recording medium. The recording medium is implemented by for example a semiconductor memory, a magnetic recording medium, an optical recording medium, etc.

Portion of the functions of the maximum throughput processor 31, the traffic measurement unit 33, the estimator 34 and the approximation formula generator 35 may be implemented by a hardware circuit. The maximum throughput information storage 32 is implemented by for example a semiconductor memory.

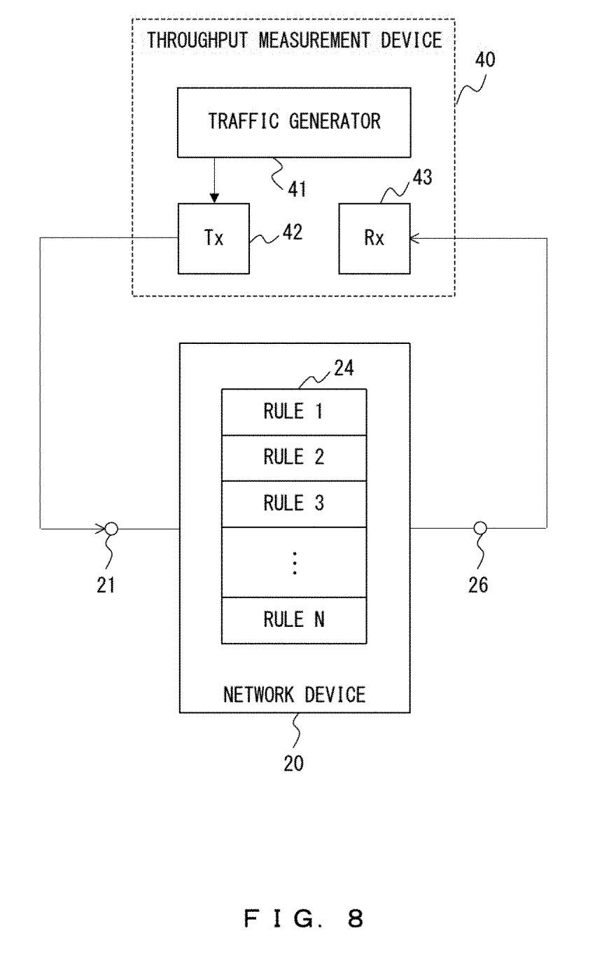

The maximum throughput processor 31 obtains maximum throughput information that indicates the maximum throughput of a network function. In this example, the maximum throughput information indicates the maximum throughput of the network function for each of rules 1-N that are registered in the rule table 24. The maximum throughput of the network function for each of rules 1-N is measured by a measurement system illustrated in FIG. 8.

A throughput measurement device 40 includes a traffic generator 41, a packet transmitter (Tx) 42 and a packet receiver (Rx) 43 as illustrated in FIG. 8. The traffic generator 41 can generate a specified flow. In other words, the traffic generator 41 can generate a test packet that includes a specified header information. The packet transmitter 42 transmits a test packet generated by the traffic generator 41 to the network device 20. Then, the network device 20 processes the test packet received from the throughput measurement device 40 in accordance with the rule table 24. The packet receiver 43 receives the test packet output from the network device 20.

When, for example, the maximum throughput is measured for rule 1 in the above measurement system, the throughput measurement device 40 generates a flow that matches rule 1. Specifically, the throughput measurement device 40 generates a test packet having header information that matches rule 1 and transmits the test packet to the network device 20. Then, the network device 20 processes the received flow in accordance with the rule table 24. It is assumed in this example that when a received test packet matches one of rules 1-N that are registered in the rule table 24, the network device 20 outputs that test packet to the throughput measurement device 40. In this case, because the received flow matches rule 1, the network device 20 outputs the received test packet to the throughput measurement device 40.

The throughput measurement device 40 outputs the flow that matches rule 1 at a transmission rate exceeding the maximum throughput of the network device 20. In this case, the network device 20 is not capable of processing all the test packets and thus discards some of the test packets. Thus, the throughput measurement device 40 can measure the maximum throughput for rule 1 in the network device 20 by monitoring the traffic volume of test packets received from the network device 20.

Similarly, the throughput measurement device 40 transmits a flow that matches rule n to the network device 20 so as to monitor the traffic volume of a flow received from the network device 20. By doing this, the throughput measurement device 40 can measure the maximum throughput for rule n (n=1 through N). Then, the measured value of the maximum throughput for each rule is reported to the workload estimator 30 from the throughput measurement device 40. Note that the throughput measurement device 40 may measure the maximum throughput for each of all rules 1-N or may measure the maximum throughputs for some of rules 1-N.

FIG. 7 is explained again. In FIG. 7, the maximum throughput processor 31 stores, in the maximum throughput information storage 32, the measured value of a maximum throughput reported from the throughput measurement device 40. Note that when the maximum throughputs are measured only for some of rules 1-N in the throughput measurement device 40, the maximum throughputs for the other rules are calculated by using an approximation formula that will be explained later.

The traffic measurement unit 33 measures a traffic volume of a flow that matches each of rules 1-N registered in the rule table 24. Traffic volume is measured by using for example the counter in the rule table 24. In this example, the counter in the rule table 24 represents the accumulated number of packets that have matched each of rules n (n=1 through N) as described above. Thus, if the traffic measurement unit 33 obtains the counter values at an interval of for example 1 second and calculates the differences between the obtained counter values, the traffic volume can be detected. It is assumed for example that the counter value corresponding to rule n obtained at a certain sampling timing is “200” and the counter value obtained at the next sampling timing is “300”. In such a case, the traffic volume for rule n is 100 frames/second (i.e., 100 fps).

The estimator 34 calculates workload WL of a network function provided by the network device 20 using the workload calculation formula below.

$$WL = \frac{{t}_{1}}{{T}_{1}} + \frac{{t}_{2}}{{T}_{2}} + … + \frac{{t}_{N}}{{T}_{N}}$$

Tₙ represents the maximum throughput of the network function for rule n (n=1 through N) that is registered in the rule table 24. The maximum throughput is measured by using the measurement system illustrated in FIG. 8 before the network device 20 provides the network function. Maximum throughput information representing a measured maximum throughput is stored in the maximum throughput information storage 32. tₙ represents the traffic volume of a flow that matches rule n (n=1 through N) registered in the rule table 24. A Traffic volume is measured by the traffic measurement unit 33.

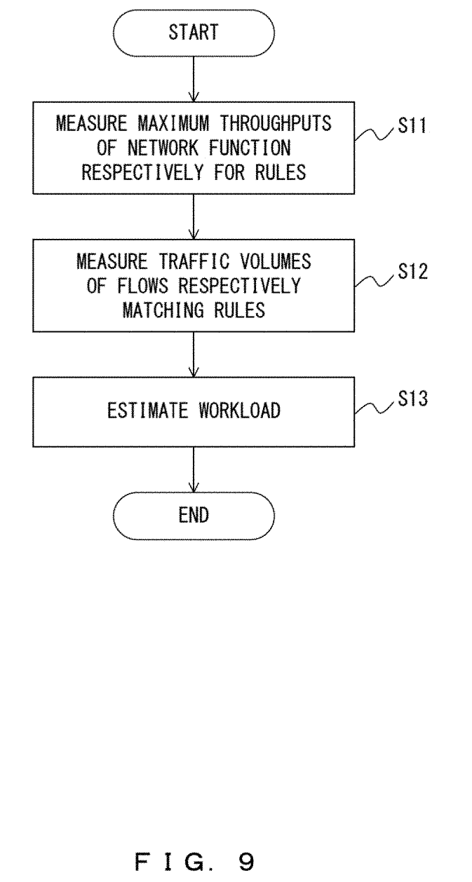

FIG. 9 is a flowchart illustrating an example of a method of estimating a workload of a network function. It is assumed in this example that the maximum throughputs respectively for all rules 1-N registered in the rule table 24 are measured by using the measurement system illustrated in FIG. 8.

In S11, the measurement system illustrated in FIG. 8 measures the maximum throughputs of the network function respectively for all rules 1-N registered in rule table 24. The measurement result is reported to the workload estimator 30. Thus, the workload estimator 30 obtains information representing maximum throughputs T₁-Tₙ respectively for the rules 1-N.

In S12, the traffic measurement unit 33 measures the traffic volumes of the flows that respectively match rules 1-N registered in rule table 24. Thus, traffic volumes t₁-tₙ respectively for rules 1-N are obtained.

Based on the maximum throughputs respectively for the rules obtained in S11 and the traffic volumes respectively for the rules obtained in S12, the estimator 34 calculates the workload of the network function. Specifically, the estimator 34 calculates the ratio of the traffic volume to the maximum throughput for each of the rules. Then, the estimator 34 calculates the sum of the N ratio values obtained for rules 1-N so as to calculate the workload imposed on the network function. That is, the estimator 34 applies maximum throughputs T₁-Tₙ and traffic volumes t₁-tₙ to the workload calculation formula so as to calculate the workload WL.

Here, the workload calculation formula will be explained. Note in the following descriptions that a throughput represents the number of packets (or frames) that can be processed in 1 second and a traffic volume represents the number of packets (or frames) that are received in 1 second.

When the maximum throughput for the n-th rule (i.e., rule n) is represented by Tₙ[fps], period of time Pₙ[s] used for processing one packet that matches rule n is expressed by the formula below.

$${P}_{n} = \frac{1}{{T}_{n}}$$

When the traffic volume of a flow that matches rule n is represented by tₙ[fps], the period of time used for processing a flow that matches rule n is represented by tₙPₙ.

Then, period of time TPT (Total Processing Time) used for processing all flows received during 1 second (the sum of flows that matches any of rules 1-N) is expressed by the formula below.

$$TPT = {t}_{1} \cdot {P}_{1} + {t}_{2} \cdot {P}_{2} + … + {t}_{N} \cdot {P}_{N} = {\sum }_{n = 1}^{N} {t}_{n} \cdot {P}_{n [ s ]}$$

When period of time TPT is shorter than or equal to “1 (second)”, the network function can process all received flows. In other words, when period of time TPT is longer than “1 (second)”, the network function fails to process some of received flows. Thus, a condition under which packet loss occurs is expressed by the formula below.

$${\sum }_{n = 1}^{N} {t}_{n} \cdot {P}_{n} > {1}_{[ s ]}$$

Further, the ratio of period of time TPT to “1 (second)” represents the level of a load imposed on a network function. Therefore, workload WL of a network function is derived from the formula below.

$$WL = \frac{{\sum }_{n = 1}^{N} {t}_{n} \cdot {P}_{n}}{1} = \frac{{t}_{1}}{{T}_{1}} + \frac{{t}_{2}}{{T}_{2}} + … + \frac{{t}_{N}}{{T}_{N}}$$

### EXAMPLE

In the example below, the workload of a network function provided by the network device 20 is estimated by using the measurement system illustrated in FIG. 8. The measurement conditions are as below.

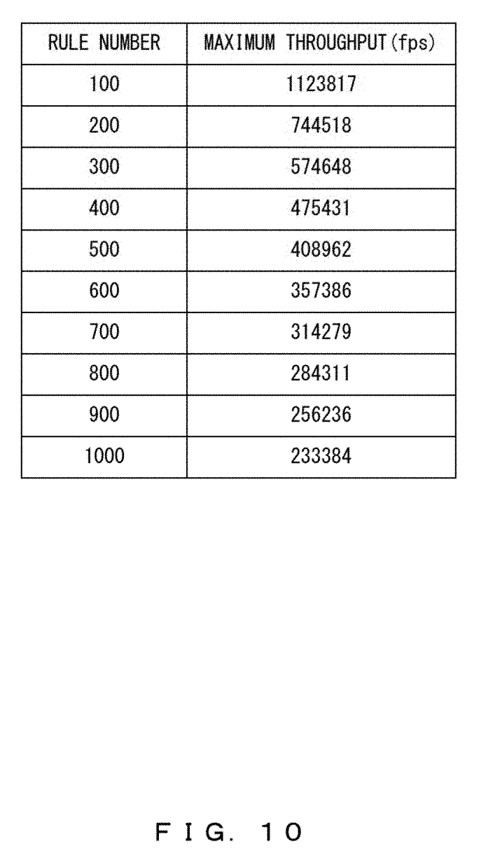

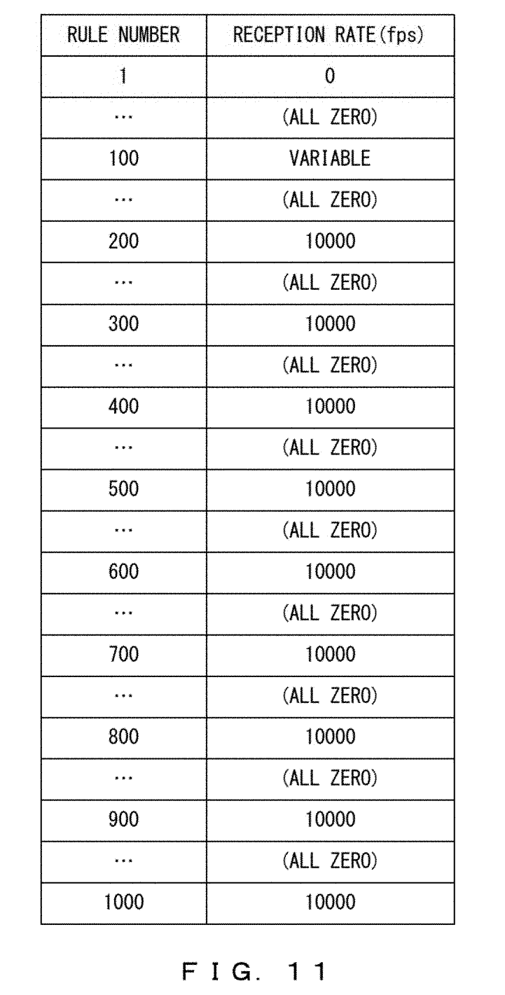

Rules 1-1000 are registered in the rule table 24. The throughput measurement device 40 simultaneously generates 10 flows that match rules 100, 200, 300, 400, 500, 600, 700, 800, 900 and 1000. The maximum throughputs that have been measured respectively for rules 100 through 1000 are as illustrated in FIG. 10. The traffic volumes of flows that respectively match rules 1-1000 are as illustrated in FIG. 11. Specifically, each of the traffic volumes of flows that respectively match rules 200, 300, 400, 500, 600, 700, 800, 900 and 1000 is 10000 fps.

Under the above conditions, the throughput measurement device 40 increases traffic volume t₁₀₀ from zero. t₁₀₀ represents a traffic volume that matches rule 100. Then, the workload estimator 30 calculates workload WL of the network function by using the workload calculation formula. When for example traffic volume t₁₀₀ is zero, the workload WL of a network function is calculated by the formula below. The calculation result indicates that the workload of the network function is about 25 percent.

$$\begin{matrix}WL = \frac{{t}_{1}}{{T}_{1}} + \frac{{t}_{2}}{{T}_{2}} + … + \frac{{t}_{1000}}{{T}_{1000}} \\ = \frac{0}{1126817} + \frac{10000}{744518} + \frac{10000}{574648} + \frac{10000}{475431} + \frac{10000}{408962} + \frac{10000}{357386} + \\ \frac{10000}{314279} + \frac{10000}{284311} + \frac{10000}{256236} + \frac{10000}{233384} \\ = 0.25316 …\end{matrix}$$

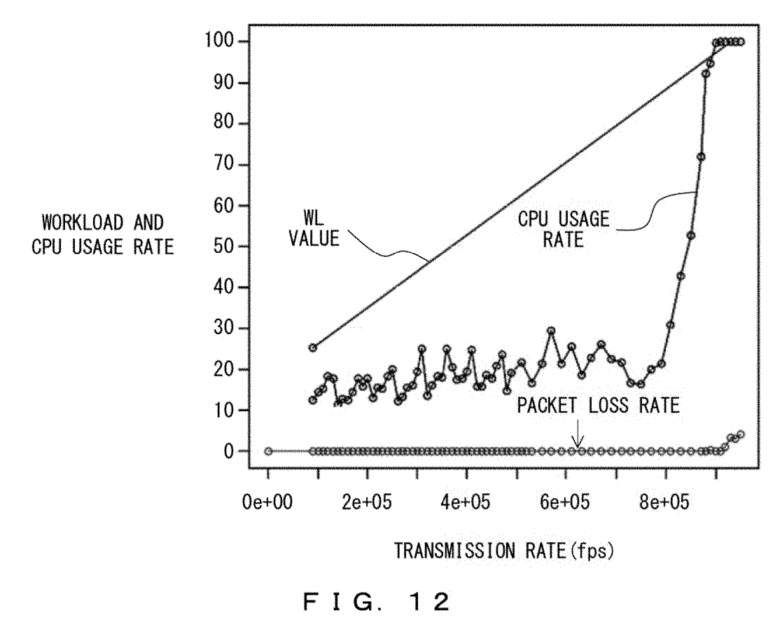

FIG. 12 illustrates an example of a calculation result of a workload WL. This calculation result is obtained by increasing, from zero, traffic volume t₁₀₀ of a flow that matches rule 100 under the conditions illustrated in FIG. 10 and FIG. 11. FIG. 12 also plots the usage rate of the CPU 25 illustrated in FIG. 4 and the packet loss ratio.

The graph illustrates that the CPU usage rate remains around 20 percent notwithstanding an increase in traffic volume t₁₀₀ (the transmission rate of a flow that matches rule 100 in this example). However, an increase in a traffic volume is supposed to increase the load on the network function. This implies that the CPU usage rate in the graph does not correctly represent the load imposed on the network function.

By contrast, workload WL is roughly proportional to the traffic volume. When the workload WL has become close to 100 percent, packet loss starts occurring. This implies that workload WL in the graph correctly represents the load on the network function.

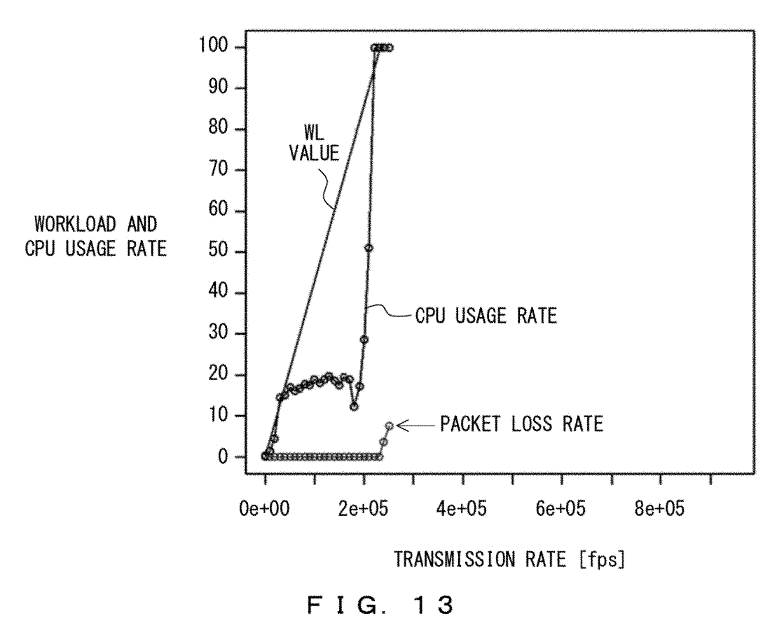

FIG. 13 illustrates another example of a calculation result of workload WL. In the example illustrated in FIG. 13, only a flow that matches rule 1000 is input to the network device 20. The transmission rate (i.e., traffic volume t₁₀₀₀) of the flow that matches rule 1000 changes. In this case as well, workload WL is roughly proportional to the traffic volume.

As described above, workload value WL obtained by a workload estimation method according to the embodiment correctly represents a load imposed on a network. Accordingly, using this workload value WL makes it possible to appropriately design the performance or capacity of a network function in accordance with the traffic of the network. For example, a network function can be designed in such a manner that higher use efficiency is achieved for network resources while suppressing or avoiding packet loss.

### Another Embodiment

When the workload of a network function is calculated by using the workload calculation formula, it is preferable that the maximum throughputs of the network function for all the rules that are registered in the rule table 24 are known in advance. However, when many rules are registered in the rule table 24, measuring the maximum throughputs for all rules registered in rule table 24 takes long time.

In view of this, in another embodiment, the throughput measurement device 40 measures maximum throughputs respectively for a specified number of rules that are extracted from among rules 1-N that are registered in rule table 24. The approximation formula generator 35 illustrated in FIG. 7 generates an approximation formula that represents the maximum throughput of a network function based on the maximum throughputs measured for the respective extracted rules. Further, the maximum throughput processor 31 uses this approximation formula so as to calculate maximum throughputs T₁−T_{N} respectively for the rules registered in the rule table 24. Then, the traffic measurement unit 33 uses thus calculated maximum throughputs T₁−T_{N} so as to estimate the workload of the network function. In the following descriptions, a method for generating the approximation formula will be explained.

In a performance model for generating an approximation formula, a processing time used by a network function to process one received packet is represented by “a+bn” “b” represents a period of time used for searching the rule table 24 once. “n” represents the number of times that the rule table 24 is searched until a rule that matches a received packet is detected. Accordingly, “bn (product of n and b) ” represents a table searching time for one received packet. Note that in this example, a search process is sequentially performed from rule 1 toward the rule N until a rule that matches the received packet is detected. Accordingly, “n” used in the performance model corresponds to a rule number. “a” represents a period of time used for processes other than table searching. For example, “a” includes a period of time used for writing a received packet to the buffer memory 22, a period of time used for reading a packet from the buffer memory 22, etc.

When the above performance model is used, an approximation model representing maximum throughput Tₙ for each rule is as below, where K represents a constant.

$${T}_{n} = \frac{K}{a + b \cdot {n}_{[ fps ]}}$$

In this example, when processing time a and searching time b are expressed in for example “second”, constant K is 1. Also, when processing time a and searching time b are expressed in “μ second”, constant K is 1000000 (1 second=1000000 micro seconds).

In order to generate the approximation formula, processing time a and searching time b are to be determined. Processing time a and searching time b are determined based on the maximum throughputs for a specified number of rules extracted from among rules 1-N registered in the rule table 24. Specifically, the approximation formula generator 35 applies, to the approximation model, the maximum throughputs for respective extracted rules and the rule numbers so as to generate a plurality of equations. Then, the approximation formula generator 35 obtains real numbers a and b by applying a non-linear least-squares method to the plurality of generated equations.

Note that the number of rules that are extracted from among rules 1-N registered in rule table 24 is not limited particularly. However, the narrower the interval for extracting rules or the smaller the number of rules to be extracted is, the higher the accuracy of the approximation formula will be. In this example, the maximum throughput greatly changes with respect to a change in a rule number in a region with small rule numbers. Accordingly, in order to achieve high accuracy for the approximation formula while suppressing the number of rules that are to be extracted, it is preferable to narrow the extraction interval in a region with small rule numbers.

For example, in a region with rule numbers 1-20, rules 1, 10, 15, 16, 17, 18, 19, and 20 are extracted. In a region with rule numbers 20-100, rules are extracted at an interval of 10 rules. In a region with rule numbers 100-2000, rules are extracted at an interval of 100 rules. In a region with rule numbers 2000-5000, rules are extracted at an interval of 500 rules.

In the measurement system illustrated in FIG. 8, the maximum throughputs are measured respectively for these rules and the measurement results are applied to the approximation model. When for example the maximum throughput measured for rule 100 is 1123817 fps, “T₁₀₀=1123817” and “n=100” are given to the approximation model so as to obtain one equation. n represents a rule number for identifying a rule and also corresponds to the number of times that the table is searched. Then, applying a non-linear least-squares method to the plurality of thus obtained equations leads to the following results.
a=0.601453
b=0.008235

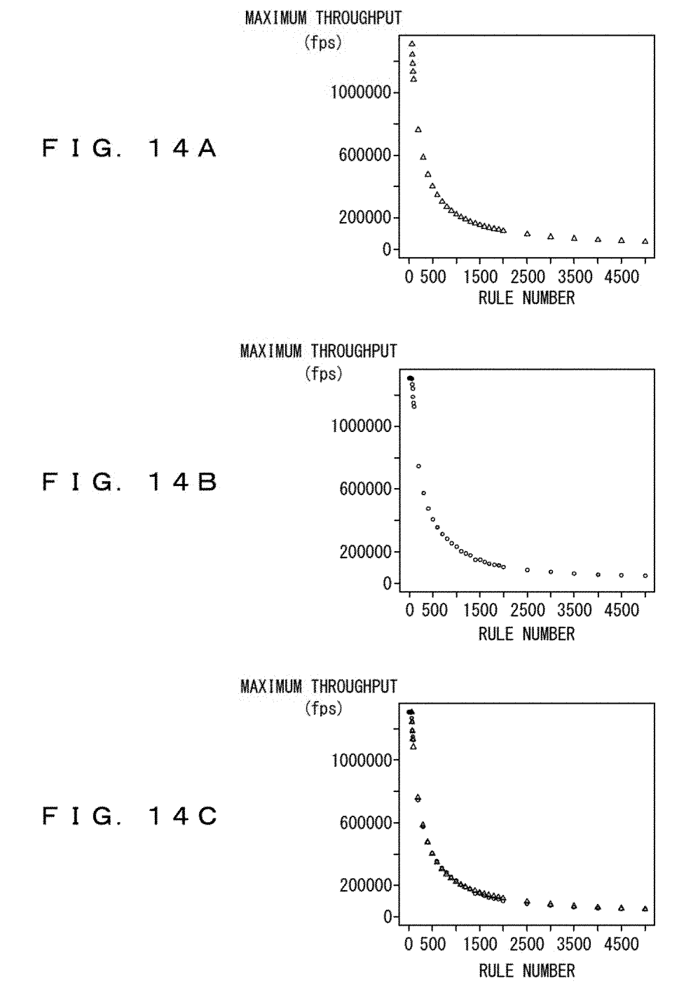

Maximum throughputs T₁-T_{N} calculated by using the approximation formula obtained as above are illustrated in FIGS. 14A-14C.

FIG. 14A illustrates maximum throughputs calculated respectively for the rules by using the approximation formula.

FIG. 14B illustrates maximum throughputs that are actually measured respectively for the rules. FIG. 14C illustrates maximum throughputs calculated by the approximation formula and maximum throughputs that are measured. As illustrated, the approximation values obtained by the above approximation formula are roughly identical to the actual measurement values.

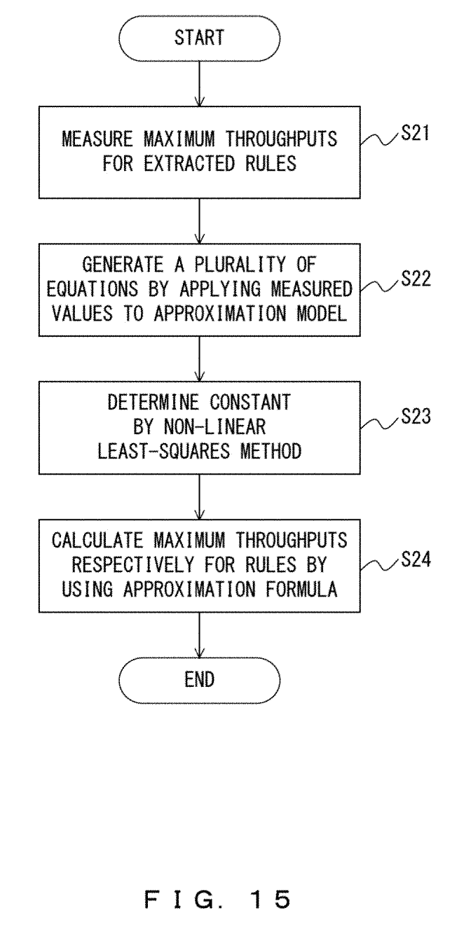

FIG. 15 is a flowchart illustrating an example of a method of calculating a maximum throughput by using the approximation formula.

In S21, the measurement system illustrated in FIG. 8 measures the maximum throughputs respectively for a specified number of rules extracted from among rules 1-N that are registered in the rule table 24. The measurement results are reported to the workload estimator 30. Thus, the workload estimator 30 obtains information representing maximum throughputs for the specified number of rules that were extracted. In S22, the approximation formula generator 35 applies, to the approximation model, the measurement values of the maximum throughputs for the extracted rules so as to generate a plurality of equations. In S23, the approximation formula generator 35 applies a non-linear least-squares method to the plurality of equations generated in S22 so as to determine the constants for the approximation model. Thereby, an approximation formula for calculating maximum throughputs is generated. Then, in S24, the maximum throughput processor 31 calculates maximum throughputs respectively for rules by using the approximation formula.

Note that the processes in S21-S24 correspond to S11 illustrated in FIG. 9. Accordingly, the network device 20 may estimate workload WL of a network function by executing S12 and S13 after calculating the maximum throughputs respectively for the rules in accordance with S21-S24.

As described above, another embodiment eliminates the necessity of measuring maximum throughputs for all rules in advance. This reduces tasks that are to be carried out before estimating a workload of a network function particularly in a case where many rules are registered in the rule table 24.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. A workload estimation method for estimating a workload of a network function that processes a received flow based on a rule searched for from among a plurality of rules, the method comprising:
obtaining, by a processor, information that indicates maximum throughputs of the network function respectively for the rules;
measuring, by the processor, traffic volumes of flows that respectively match the rules;
calculating, by the processor, ratios of the measured traffic volumes to the maximum throughputs respectively for the rules; and
estimating, by the processor, a workload of the network function based on a sum of the ratios calculated respectively for the rules.

2. A workload estimation method for estimating a workload of a network function that sequentially performs a search from a first rule toward an N-th rule until a received flow matches one of N rules so as to processes the received flow in accordance with the rule that matches the received flow, the method comprising:
obtaining, by a processor, information that indicate maximum throughputs of the network function respectively for the rules;
measuring, by the processor, traffic volumes of flows that respectively match the rules; and
estimating, by the processor, a workload of the network function based on a workload calculation formula below:
$$WL = \frac{{t}_{1}}{{T}_{1}} + \frac{{t}_{2}}{{T}_{2}} + … + \frac{{t}_{N}}{{T}_{N}}$$
where Tₙ represents a maximum throughput of the network function for the n-th rule in the N rules, tₙ represents a traffic volume measured for a flow that matches the n-th rule in the N rules, and n represents an integer from 1 through N for identifying each of the N rules.

3. The workload estimation method according to claim 2, further comprising:
measuring, by the processor, a maximum throughput of the network function for each of a plurality of extracted rules that are extracted from among the N rules;
generating, by the processor, an approximation formula that expresses a maximum throughput of the network function based on the maximum throughput measured for each of the extracted rules; and
calculating, by the processor, a maximum throughput of the network function for each of the N rules by using the approximation formula, wherein
the workload of the network function is estimated by applying the maximum throughput calculated for each of the N rules to the workload calculation formula.

4. The workload estimation method according to claim 3, wherein
the approximation model that represents the approximation formula is expressed by
$${T}_{n} = \frac{K}{a + b \cdot n}$$
and wherein a plurality of equations are generated by applying, to the approximation model, the maximum throughput measured for each of the extracted rules and integer n that identifies each of the extracted rule, and
the approximation formula is generated by applying a non-linear least-squares method to the plurality of equations and obtaining the real number a and the real number b in the approximation model.

5. A workload estimation device that estimates a workload of a network function that processes a received flow based on a rule searched for from among a plurality of rules, the device comprising:
a memory in which the plurality of rules are registered; and
a processor configured to:
obtain information that indicates maximum throughputs of the network function respectively for the rules registered in the memory;
measure traffic volumes of flows that respectively match the rules registered in the memory;
calculate ratios of the measured traffic volumes to the maximum throughputs respectively for the rules registered in the memory; and
estimate a workload of the network function based on a sum of the ratios calculated respectively for the rules registered in the memory.

6. A non-transitory computer-readable recording medium having stored therein a program for causing a computer to execute a workload estimation process, the workload estimation process comprising:
obtaining information that indicates maximum throughputs of the network function respectively for the rules;
measuring traffic volumes of flows that respectively match the rules;
calculating ratios of the measured traffic volumes to the maximum throughputs respectively for the rules; and
estimating a workload of the network function based on a sum of the ratios calculated respectively for the rules.
